(19) United States
(12) Patent Application Publication
(10) Pub. No.: US 2015/0170261 A1
(43) Pub. Date: Jun. 18, 2015

(54) Method and System for Renting Property

(71) Applicants: Mathieu STREMSDOERFER, Duebendorf (CH); Philippe HOFFMANN, London (GB)

(72) Inventors: Mathieu Stremsdoerfer, Duebendorf (CH); Philippe Hoffmann, London (GB)

(21) Appl. No.: 14/407,864

(22) PCT Filed: Jun. 14, 2013
(86) PCT No.: PCT/US13/45988

§ 371 Date: Dec. 12, 2014

Related U.S. Application Data
(63) Continuation of application No. 13/524,880, filed on Jun. 15, 2012.

(51) Int. Cl. G06Q 30/06

(52) U.S. Cl. CPC G06Q 30/0645

(57) ABSTRACT

The invention is a system and a method for renting portable property, which can be a pre-purchase sample. The invention includes catering identification of an article onto the Internet. Receiving a plurality of requests via network from potential lessees to rent the article for requested rental periods then occurs. Sorting occurs for the requests to rent the article according to a chronology of the requested rental periods. Then, agreeing via network to rent the article to a plurality of lessees occurs. Transferring possession of the article from a lessor to a first lessee occurs such that the first lessee is the first in the chronology of the sorted, requested rental periods. Transferring sequentially the article between lessees according to the chronology of the sorted, requested rental periods is performed. Monitoring each rental and transfer of the article is done. Then, distributing a payment for each rental of the article occurs.

### BACKGROUND OF THE INVENTION

1. Field of the Invention

The invention relates to a system and a method for renting an item through a chain of users or renters. Specifically, the invention relates to a system and a method for transferring an item, especially a physical article, through a series of consecutive renters.

2. Description of Related Prior Art

The term “Internet” refers to a global system of interconnected computer networks. These networks use a standard “Internet protocol” (TCP/IP) to serve users worldwide. The Internet is a network of networks that consists of millions of private, public, academic, business, and government networks. The Internet carries information resources and services, such as the inter-linked hypertext documents of the World Wide Web (www) and the infrastructure to support email.

Commerce of the Internet has proliferated. A member of the public seeking consumer goods can communicate with and purchase directly from manufacturers, retailers, or other distributors of goods and services. Some distributors, such as Amazon, specialize exclusively on Internet sales. Typically, a consumer can research goods or services, compare prices, and purchase the goods or services over the Internet.

A consumer purchasing goods or services over the Internet identifies a vendor from which the purchase will be made. The consumer then selects the item being purchased and provides the information necessary to pay for the good or service. The payment can be by credit or debit card or through a third-party transaction service, such as PayPal. The payment requires sufficient information from the consumer to transfer funds from the consumer to the vendor.

Goods are sent to the purchasing consumer by mail or a parcel service. Occasionally the consumer will return the goods and may receive a full or partial refund. The return can be processed over the Internet. The vendor can generate a return label for the consumer to apply to the packaging of the goods to be returned. The procedure can also establish a “pick-up time” for the goods by the post office or parcel service. The return of funds can be generated by the vendor into an account for the consumer.

Traditional web rental services (for example, the “zilok.com” website) offer physical articles for rent through systems which allow the lessee or renter to obtain an article from the lessor or owner. The renter must return the article to the owner at the end of the rental period.

Certain rental transactions are known as “rent to own” transactions wherein the renter can own the item or article, usually, by paying an additional fee at the end of the rental period.

Korean Patent Application Number KR20030065944 describes a system and a method for renting online a vehicle to a renter, who wants the vehicle rapidly. The lessors or owners possess rental vehicles, and the vehicles are distributed in each area independently. A rental service company stores and possesses information in a computer server regarding rental vehicles possessed by lessors. The computer server integrally manages all business with respect to the rental and the management of the vehicles from the moment a vehicle is requested online and the renter's information is provided. A plurality of client data input units can request the rental of vehicles from a lessor and the rent service company. An Internet network connects the rental service company, the lessor, and the client data input units interactively online. However, this system and method require the return of the vehicle after the rental period.

An improvement on those services is provided by other rental platforms such as that of the web site mobility.ch/en/pub/index.cfm. This web site offers vehicles for rent through systems which allow the renter to borrow a vehicle at a specific location and return it to the same location without intervention of a lessor. This system uses specific access and authentication mechanisms via a mobile network.

Korean Patent Application Number KR20070073706 describes a system for managing bicycles equipped with an RFID system, which rents, collects, or stores the bicycles without human intervention by installing an RFID tag to each bicycle. Each bicycle is equipped with as bicycle lock, and the RFID tag is attached to the lock. The system uses one or more bike stands or “depositories” equipped with stand locks and RFID readers for reading information on the RFID tags. A control system controls a network of depositories and bicycles. The RFID reader is installed on one side of a bicycle stand. Each depository includes an unstaffed terminal for transceiving information with the RFID reader. The control system includes a server for monitoring the database of bicycle information and bicycle usage information.

U.S. Patent Publication Number 2004/0068451, now abandoned, discloses a system and method for managing the inventory level and distribution of electronic media rental units, including, but not limited to, videogame discs, musical compact disks, or movie VCD/DVDs. More specifically, preferred embodiments of the present invention forecast future rental and sales demand for a given electronic medium, such as a videogame, prior to release of that electronic medium to the general public. The forecast is based on the pre-release demand of the electronic medium in that future rental, and sales demand is estimated from the rental and sales demand of previously released electronic media having similar pre-release demand. Furthermore, the preferred embodiment of this invention allows registered members of a rental user group to keep rented units of the electronic media for a purchase price, which is dynamically controlled to minimize rental shortages and maximize profits.

U.S. Patent Publication Number 2009/0327031 describes a system and method for renting and buying a digital media article. In this system the renter, who wants to keep the article at the end of the rental period, has the option of buying the article at a discounted price via removal of the digital restriction, which is attached to the use of the article. If the renter decides not to keep the article, the system will release the digital rights attached to the article. In this system and method, the article changes ownership permanently when a renter decides to buy the article. Otherwise, the article remains the property of the original owner, when the renter elects a lease of the item.

The background art, including the art discussed above, presents a number of drawbacks. These drawbacks include unnecessary transports of the rented articles to the lessors or owners and unnecessary involvement of the lessors or owners in the rental procedures.

The first and second examples of art discussed above (i.e., zilok.com and Korean Patent Application Number KR20030065944) require that the rented article be returned at the end of the rental period by the lessee or renter to the original lessor or owner. This requirement generates a large number of transports of the article back and forth from or to the owner. These transports of the article increase the overall complexity of the system or method with the associated costs. In addition, the original lessor or owner must be actively involved in each rental of the article, which generates additional management costs.

The third and fourth examples of art discussed above (i.e., mobility.ch/en/pub/index.cfm and Korean Patent Application Number KR20070073706) require the lessees or renters to return the rented articles at the end of the rental periods. Return of the articles generates additional transport needs and increases costs of the rental.

The fifth and sixth examples of art discussed above (i.e., U.S. Patent Publication Numbers 2004/0068451 and 2009/0327031) offer the lessees or renters the opportunity to buy the articles instead of returning them. The purchase of an article reduces transport costs, but this benefit is only realized in the scenarios where the lessee agrees to buy the article. The purchase of the article in the systems and methods of the background art has the disadvantage of removing the purchased article from further availability in the rental system.

The background art lacks a system and a method for renting an item through a chain of users. An objective of this invention is to provide a system and method for transferring an item, especially a physical article, through a series of consecutive renters. The invention provides the further ability to rent an article within the system even if the ownership of the article changes from its original owner within the system.

### SUMMARY OF THE INVENTION

The present invention resolves the drawbacks of the background art through a system and a method in which the lessee or renter avoids the requirement for returning an item or article to the original lessor's or owner's location. The invention enables the lessor or renter to keep the item or article after the rental period, without transfer of ownership, until another user requests the item or article. For purposes of this invention, this transaction wherein a first renter retains possession of an item or article after the rental period and passes possession of the article to a new renter within the system is identified by the term “rent and keep.” The lessee or renter is remunerated at the time of transfer of the article to the next lessee or renter. Remuneration can be an exchange for value or no value and can include a coupon, future discount, additional service, faster shipment, and the like.

The invention is a system and a method for renting portable or physically transferrable property. The invention includes entering on a processor and storage system via an information network identification of an article of portable property for rent. Receiving a plurality of requests via the information network from potential lessees to rent the article for requested rental periods then occurs. Sorting by the processor and storage system occurs for the requests to rent the article according to a chronology of the requested rental periods. Then, agreeing via the information network to rent the article to as plurality of lessees according to the chronology of the requested rental periods occurs. Transferring possession of the article from a lessor to a first lessee occurs such that the first lessee is the first in the chronology of the sorted, requested rental periods. Transferring sequentially the article between lessees according to the chronology of the sorted, requested rental periods is performed. Monitoring for the lessor by the processor and storage system each rental and transfer of the article is done. Then, distributing by the processor and storage system a payment for each rental of the article occurs.

The system or method of the invention reduces the requirement for transporting an item or article back and forth to the lessee's or owner's location or approved site. The invention minimizes the management overhead of the lessor or owner and can increase the potential to rent the article multiple times since the article can be transferred from user to user without intervention by a third party or the owner.

Another advantage of the invention is that it can provide access to the system to any user who is as potential purchaser of an article. The system or method can convey information related to the item or article for rent which is relevant to a prospective buyer.

Another advantage of the system is that it automatically manages the inventory of the article without requiring the intervention of the lessor. The inventory management is based on the available bookings on the platform. This calculation is a key differentiation over traditional peer to peer rental solutions, where the inventory is usually not managed, or traditional rental solutions, where the lessor must manage the inventory.

Another advantage of the invention is that the system and method provide marketers with a unique solution to perform “real product” trials in a geographical market area with (1) users' social media conversations, (2) trial data such as but not limited to anonymous usage data, user reviews, and socio-demographics, as well as (3) identifying ambassadors for the product who can become leaders of opinion for social network followers, and (4) testing conversion rates after trial of the real product. This solution is cost effective because it does not necessitate large investments such as those required to open a store in a physical or “brick and mortar” world. This solution is social in nature and therefore radically different from the traditional user tests of individual product testing or individual sample testing. Finally, this solution happens in the real world and not in a lab or other artificial environment such as current interactions with users groups.

Another advantage of the system is that it permits potential customers to rent a trial product or sample of a product. Desirably, trial products or samples are rented via a chain of trusted users. Trial products or samples are desirably rented at no cost for a limited time without an obligation to buy. Retailers for products, such as shoes, can reduce the number of their product returns and increase sales, thereby significantly improving their bottom line.

Renting a trial product or sample provides a savings to the retailers because:
A sample of the same product can be tried multiple times by different customers;
The customer does not need to return the sample to the retailer; and
The rent and keep “limited free trial” method divides by two the number of shippings incurred by a retailer versus a rent and return “limited free trial” method.
   Renting a trial product or sample improves sales before a purchase of a non-sample of the product because:
Free product trials encourage more buying by customers; and
Free product trials by using the invention create more word of mouth, awareness, a feeling of customer community akin to a free marketing program around the retailer's products.

The system is readily operated or supported by an online Internet processor, such as a computer or “smartphone.” The principle of the system and method is explained below in detail.

### BRIEF DESCRIPTION OF THE DRAWING

The attached drawing illustrates the implementation of the concepts conveyed in this application.

FIG. 1 is a flow chart of the invented process of three basic transactions performed by the invented system or method.

### DETAILED DESCRIPTION OF THE INVENTION

The present invention is a system and a method in which the lessee or renter avoids the requirement for returning an item or article to the original lessor's or owners location. The invention enables the lessee or renter and keep the item or article after the rental period, without transfer of ownership, until another user requests the item or article. The lessee is remunerated at the time of transfer of the item or article to the next lessee or renter. Remuneration can be an exchange for value or no value and can include a coupon, future discount, additional service, faster shipment, and the like.

Man-made goods include “personal property” as well as dwellings on land, which are considered “real property” or real estate. Personal property is typically a “physical article,” something that can be touched. Most personal property can be moved unlike real property, which is immobile on a plot of land.

It is understood that approximately one-fourth of all goods ever made by mankind were made in the decade preceding this invention. Many of these goods are durable, physical articles of personal property with long terms of usefulness. For example, a set of hand tools can remain useful for generations while machinery, such as lawn mowers, can remain operative for years. Many of the items or articles owned by an average consumer are only required by that consumer or user for specific needs of short duration. These specific needs may be random, such as a need for hand tools when machinery owned by a user breaks, or seasonal, such as a lawn mower one afternoon a week in the spring and summer months. Most of the life of an item or article is spent in idle storage.

The vast majority of users of items and physical articles of personal property live in relatively close proximity to other potential consumers or users of the items or articles. The need by these potential users for the particular items or articles is no greater in duration than that of the owners of the articles. The expense of purchasing such personal property that will spend most of its useful life lying idle in storage is unnecessary if the item or article can be readily available at a reduced expense.

This invention includes a system and a method using a processor and data storage device or system such as a digital memory device in at least one computer, a series of electronic devices, or similar device. The storage can be as simple as an electronic device that wirelessly connects to the Internet or comparable source of data and information.

The information used by the system or method is stored securely on a server and is accessible online or via a mobile device such as a “smartphone.” Desirably, this information may be completed by default according to system rules.

The following definitions are used for the purpose of describing the preferred embodiment of the invention. These definitions are for exemplary purposes and are not intended to be limiting to the invention.
A “lessor” is a person, company, entity, or an agent thereof that initially places an item or article into the system for rent. The lessor is usually the owner of the item or article.
A “lessee” is the person, company, or entity that rents the item or the article through the system or method of the invention.
A “temporary provider” (sometimes abbreviated as “TP(X)”) is the person, company, or entity that transfers the item or the article to the next lessee. Typically, the initial transfer of the article is from the lessor to a lessee. Lessees automatically becomes temporary providers when they agree to rent an article with the “rent and keep” method.
An “article” for purposes of this exemplary description is the personal property, which is offered for rent. The broad categories of personal property were defined above as including physical items and articles. The term “article” is not intended to limit the type of personal property to be rented through the system or method of the invention.
   It is noted that as “user” of an article it the system or method of the invention can be both an owner or renter (a lessee) of the article. As explained below, an article within the system or method can change owners. A new owner can initially be a renter and can elect to become a lessor within the system or method of the purchased article.

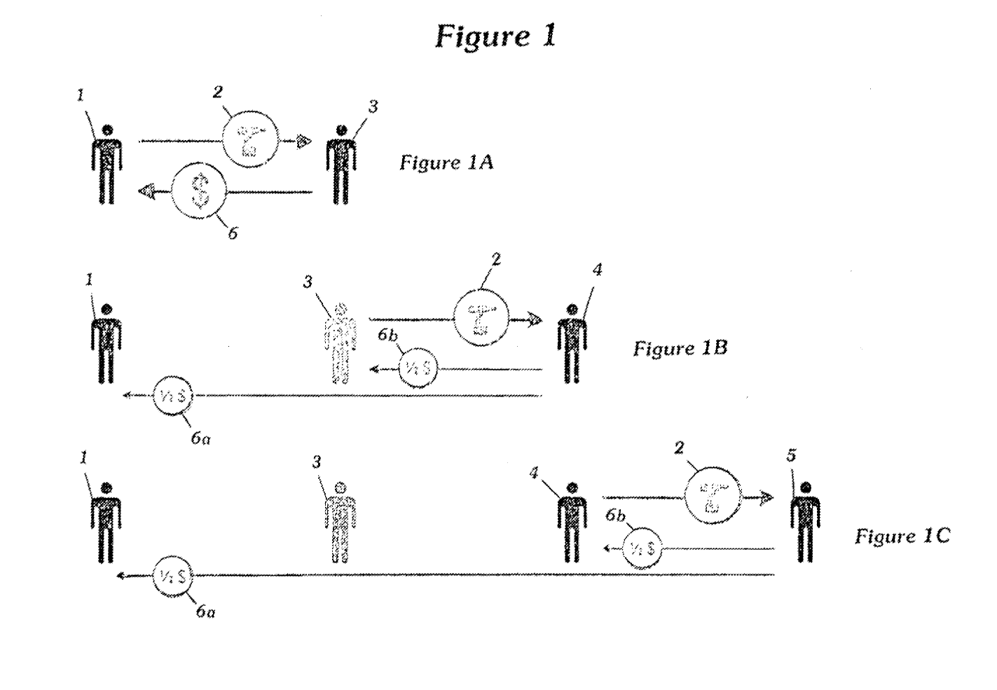

FIG. 1 illustrates a preferred embodiment of the system and the method of the invention. A lessor 1 creates a profile in the system or software application online or on a wireless device, such as a smartphone.

A desirable embodiment of the invention detects the location of lessor 1 by an Internet Protocol geographical locater, GPS system, or similar sensing device. However, the invention must permit the entry of a stationary location to be entered such as home, business, or storage address. Based on the detected or otherwise entered location of lessor 1, the software of the invention can select a language automatically, which can be changed. This feature can be beneficial in geographical areas, such as Europe, wherein numerous languages are used within a relatively small geographical area. The software can request lessor 1 to accept the automatic selections.

Desirable embodiments of the software of the invention can permit a lessor 1 use manual entry of data as well as a third party system, such as social media (for example, media currently provided under the trademarks Facebook or Twitter) to connect to the system of the invention and create the profile of the lessor 1. Such profile information includes, for example, the individual name or company name of lessor 1 as well as the contact (e-mail, phone, cell phone), login password, and contact preferences (free text) of lessor 1, socio-demographics, friends network, and user preference. The address location can be automatically determined by the system via geographic localization (GPS) and can be changed by lessor 1.

The software of the system requests lessor 1 to confirm his or her acceptance of the terms of service and general conditions. The system software generates a unique user identification (“ID”) and can send an e-mail to lessor 1 to verify his or her profile entries. Lessor 1 is then automatically logged in.

Lessor 1 enters an article 2 for rent (in this example, a drilling machine) as an article within the system or a “rent and keep” article. This entry can desirably be done online or by a wireless device for a single article or a batch of comparable articles.

Lessor 1 can manually enter or, desirably, scan via a smartphone, digital camera, RFID reader, or comparable optical device identifying information of the article 2. It is also possible with certain systems that this procedure can be performed automatically. The identifying information can include, but is not limited to, a barcode, a QR code, a serial number, an electronic ID, an active digital identity, an RFID tag, a radiation marker, or another unique reference. In case such a unique reference does not exist or is not practical to enter, the system desirably generates its own identifying reference, which can be used later as a unique identifier and placed on the article in the form of a serial number, barcode, QR code, RFID tag, or other identifier.

The system desirably automatically enters the relevant article information such as title, description, and optional characteristics (for example, type, color, size, category, photograph, keyword, etc.) previously stored in association with the unique identifying reference. The system software desirably permits lessor 1 to enter the identifying information manually. Lessor 1 desirably can enter at least one photograph or video of article 2 via the entry device such as a computer or smartphone.

Lessor 1 can select the type of rental category for article 2. For example, the selection of the “rent and keep” category indicates that the article is kept by the lessee after termination of the rental period. (See mobile Example 1 below.) This category is desirably a default selection of the system software.

As an option, lessor 1 can allow the article 2 to be rented under “rent and return” category. Article 2 desirably can be returned to lessor 1 at any time during the “rent and keep” process for maximum user choice.

Lessor 1 desirably enters the value of article 2 and an optional deposit for the article. The system can desirably provide a default value based on previous information or a pool of data including values for similar articles. This amount can be zero or any amount above zero.

Lessor 1 enters the rental period and price. The system desirably can recommend a rental price based on, but not limited to, the article category, article value, and/or rental price for similar products previously entered into the system. This price might be expressed in a real currency or in a virtual currency such as credits or points awarded to lessors or users of the system. A rental price is typically associated with a rental period.

Lessor 1 also desirably enters at least one rental period. Typically, a rental period is expressed as at least a day, but it can be a price per week-end, weekdays, 30 days, or other lengths of time. Different rates of prices can be provided when an article is offered for multiple rental periods. Desirably, the article can also be booked only for a fixed rental period with a fixed price, which can be zero. This simplifies the booking process, and is particularly relevant for product trials, typically expressed as “you can have it for X days, where X represents the number of days the article may be booked.”

Lessor 1 can select rental restrictions. Such rental restrictions can include the following.
A maximum geographical rental area within which article 2 is authorized to travel. The maximum geographic rental area ensures the lessee is located within a zip code, city, region, country, or space defined by a distance around the original location of the article.
Minimal rental period to ensure the article is borrowed for a minimum rental period.
Maximum rental period to ensure that other lessees can borrow the article as well.
The item can be booked only once (for instance for product trial).
Dates when the lessor does not desire article 2 to be available to lessee or at which the article needs to be returned.
Lessor 1 can define an approval process for qualifying subsequent lessees. This approval process provides approval criteria for the next lessee requesting the article in lieu and in place of as temporary provider. The approval process and a temporary provider can be entered by a default setting.
Lessor 1 can establish rental conditions for lessees. These conditions can include the required deposit, lessee identification, identification verification, age, manner by which lessor 1 can be contacted, and similar conditions.
Lessor 1 can establish insurance requirements to be verified by lessees or identify the extent of the lessor's insurance coverage on the use of the article by others.
Lessor 1 can desirably establish contract requirements. For example, lessor 1 can require that a contract be signed between a temporary provider and a lessee.
   Other rental restrictions can desirably be entered by lessor 1, which are customary or fitting to the article being entered into the system.

The current article location can be entered manually but is desirably provided automatically, preferably via geographic coordinates from a GPS or similar tracking device. If such a location system is not available, the location of lessor 1 can be entered by default or as location can be entered by lessor 1.

Finally, lessor 1 enters the compensation of the temporary provider who provides the article to the next lessee. Typically, it is expressed as a percent of the next lessee rental price, but it can also be a fixed sum expressed in a currency or points. This compensation can also be set by default by the system for simplicity sake. Desirably, this compensation could increase if the temporary provider recruits the next lessee (for instance, via his or her social connections).

Lessor 1 confirms the terms and conditions and fair usage policy (see mobile Example 1). A fair usage policy defines the manner by which the article can be used by a lessee after the rental period ends and the article remains with the lessee. Special terms and conditions define the manner by which the user must respond to as request from another prospective user to rent the article or as request from the lessor to recover the article 2. The article is then available for rent in the system via the “rent and keep” process.

FIG. 1A illustrates the initial procedures of the system and method of the invention. After lessor 1 enters basic identifying information for the lessor and the article 2, the system and method require a lessee 3 to seek or search for an article in the category or type of the article 2. The lessee 3 searches tot a product online or on a wireless device via the system application of the invention.

The system facilitates this search by providing an interface that shows a search field, and a list of the articles available starting from the location where the search is performed with a description, the price and duration information, and the distance from the lessee. Desirably, the system provides the possibility to see those articles on a map, and to filter those articles based on various criteria known in the database of the system such as “my items,” “my borrowed items,” “my friends items,” “my group items,” “items people are looking for,” price, reviews, (stars given by users for a given article), item availability (based on current bookings) categories or keywords. For instance, selecting “my items” enables the user to select his or her items, with the purpose of editing or recalling the items which have been added in the system. “Friend items” are items that belong to friends via a social network such as that provided under the trademark Facebook. “My group items” are items that belong to a group of people to whom the user also belongs.

Lessee 3 must find a product (in this example, article 2) in which lessee 3 is interested in renting as a “rent and keep” article. If lessee 3 does not find a specific product, the system desirably provides the ability to enter a title and description for this specific product, which is then added to the category of items “items people are looking for.” This way, other people can see this request in the system and add the missing item.

Lessee 3 contacts a first temporary provider is the system application software. This procedure involves lessee 3 logging onto the platform of the invention. Lessee 3 creates a profile on the application in the same manner as described above for lessor 1. Lessee 3 also creates a request for the desired article with a start and end date unless this rental is a fixed duration, in which case only a start date is needed. It is also possible for a system to provide a start date, such as the next available date, automatically. The rental price is calculated automatically by the system software.

The next procedural step involves the lessor 1, in the capacity of a first temporary provider receiving the request from lessee 3 via a notification sent by the system software, for example, by e-mail or text to a computer or smartphone. Lessor 1 as the first temporary provider can desirably elect to accept or refuse the request of lessee 3 based on a set of information provided by the system such as user identification and verification, past transaction success, and user reviews. Alternatively, the first temporary provider can contact lessee 3 for modification of the request via various communications channels available through the system (including but not limited to e-mail, notification, and contact by phone). In this situation, lessee 3 can modify his or her request. For purposes of this example, the first temporary provider accepts the “rent and keep” request of lessee 3.

Lessee 3 confirms the request by making a reservation payment or deposit. Desirably, this procedure requires lessee 3 to accept the terms and conditions and fair usage policy. The reservation payment desirably includes (1) the price of the system intermediation or usage fee, (2) the price accepted by lessor 1, and (3) the price of the temporary provider unless the fee of the temporary provider is paid directly when lessee 3 and the temporary provider meet for exchange of the article. This payment 6 can be done online, over a smartphone, or with a similar device.

A payment 6 can include a procedure wherein a lessee buys credits or points, which can then be used to pay for the rental of the article. When a deposit is required, a credit card number or payment code (such as used by services provided under the trademark PayPal) can be required by the payment module of the system software to request authorization for the deposit amount. A rental reservation confirmation is sent to lessor 1, the temporary provider, which may be subsequent to lessor 1, and lessee 3. A contract is desirably sent to the temporary provider, for example, by e-mail, for lessee 3 and the temporary provider, which can be optionally signed or otherwise confirmed electronically.

The next procedure involves transfer of the article from the control or possession of the temporary provider to lessee 3. This transfer can be an in-person meeting, or lessee 3 can be directed to the location of the article 2 and provided with instructions for unlocking any security device protecting the article 2. Normally, lessee 3 will meet at the temporary provider's proposed location. Alternatively, the temporary provider can ship the article 2 to lessee 3. Shipping the article is particularly desirable for low value items such as a book, DVD, game, etc. The responsibility for the cost of the shipping can be a negotiated item or part of the lessor's or temporary provider's terms and conditions.

In this transfer procedure, the temporary provider transfers possession of the article to lessee 3, desirably with instructions on how to use the article 2. Lessee 3 inspects the article. Lessee 3 can accept or reject the article from the temporary provider.

If lessee 3 chooses to reject the article, the rejection is desirably entered into the system application. This action triggers a notification to lessor 1 and desirably a cancellation of the payment previously made.

If lessee 3 chooses to accept the article, lessee 3 provides or arranges for payment to the temporary provider, if needed, and confirms transfer of the article from the temporary provider by a simple validation module within the system application, which can be made online or by a wireless device. The item is then automatically assigned by the system to the physical location identified by lessee 3. This procedure can optionally include lessee 3 signing or acknowledging a contract tendered by lessor 1 or a temporary provider. By agreeing to rent article 2 with the “rent and keep” method, lessee 3 automatically becomes the temporary provider for the next user requesting the article.

The next procedure is the use of the article 2 by lessee 3. At the end of the rental period, lessee 3 retains possession of the article under the fair use policy instead of returning the article to lessor 1. The article is automatically available for the next user or lessee 4 to request.

Alternatively, lessee 3 has the possibility of extending the article 2 booking into the future to a new end date or to book the article for a new date in the future if the article has not already been requested by another user in the system and the system allows for it.

An optional procedure can be provided by the system for a user review. Lessees or temporary providers desirably are able to enter comments regarding their experience with the previous temporary provider and or the article into the system. Such review are typically entitled “would you recommend this experience to a friend?”

After transfer of the article 2, a review notification is forwarded to both the temporary provider and the lessee. The temporary provider can review the experience of meeting lessee 3, if applicable. Lessee 3 can review the experience of meeting the temporary provider and using the article by giving stars and adding comments.

The system and method of the invention are illustrated in FIG. 1B. The steps or procedures of FIG. 1A described above are performed.

A new prospective lessee 4 then searches for article 2 online or with a wireless device using the system application of the invention. Lessee 4 identifies article 2 as the product in which he or she is interested in renting as a “rent and keep” article.

Lessee 4 contacts the temporary provider via the system application. The lessee 4 must be logged in on the platform for this procedure. Lessee 4 desirably creates a profile on the system application in the same manner as described above for lessor 1 and lessee 3.

The procedure then requires lessee 4 to create a request for the product or article 2 preferably with a start and end date unless this is a fixed duration rental in which case only a start date is needed. Rental price is calculated automatically.

The system and method involve a procedure wherein the temporary provider receives the request from lessee 4 via a notification system such as e-mail to a computer, wireless device, or similar device.

The temporary provider can desirably accept or refuse the request from lessee 4 based on a set of information provided by the system such as user identification and verification, past transaction successes, and user reviews. The temporary provider can contact the lessee 4 for modifications of the rental arrangement via the various communication channels provided by the system. In this situation lessee 4 can modify his or her request. For purposes of this example, the temporary provider accepts the “rent and keep” request from lessee 4.

The procedure then involves confirmation of the request from lessee 4, which can be made by the payment of a reservation or deposit fee. Desirably, this procedure includes the acceptance by lessee 4 of the terms and conditions and the fair usage policy.

This reservation payment desirably includes the price of the system intermediation or usage fee, the portion of the rental payment due to the lessor 1 or owner, and the portion of the price due to the temporary provider unless the temporary provider is paid directly when lessee 4 and temporary provider meet for transfer of article 2.

This payment 6 can be done online or via a wireless device such as a smartphone. Payment can include the acquisition of system user credits or points, which can be used to pay for rental of the article. When a deposit is requested, a credit card number or payment code (such as used by services provided under the trademark PayPal) is required by the payment module of the system software to request authorization for the deposit amount. A rental reservation confirmation is sent to lessor 1, the temporary provider, which is subsequent to lessor 1, and lessee 4. A contract is desirably sent to lessor 1 (the owner), the temporary provider, and lessee 3, for example by e-mail. The contract can be optionally signed or otherwise confirmed electronically.

The next procedure involves transfer of the article from the control or possession of the temporary provider to lessee 4. This transfer can be an in-person meeting, or lessee 4 can be directed to the location of the article and provided with instructions for unlocking any security device protecting the article. Normally, lessee 4 will meet at the temporary provider's proposed location. Alternatively, the temporary provider can ship the article to lessee 4. Shipping the article is particularly desirable for low-value items such as a book, DVD, game, etc. Responsibility for shipping costs can be a negotiated item or part of the lessor's or temporary provider's terms and conditions.

If lessee 4 chooses to reject the article 2, the rejection is desirably entered into the system application. This action triggers a notification to lessor 1 (the owner) and temporary provider and lessee 3 and desirably a cancellation of the payment previously made.

If lessee 4 chooses to accept the article 2, lessee 4 provides or arranges for payment to the temporary provider, if needed, and confirms transfer of the article from the temporary provider by a simple validation module within the system application, which can be made online or by a wireless device. The item is then automatically assigned by the system to the physical location identified by lessee 4. This procedure can optionally include lessee 4 signing or acknowledging a contract tendered by lessor 1 or the temporary provider. By agreeing to rent article 2 with the “rent and keep” method, lessee 4 automatically becomes the temporary provider for the next user requesting the article. The system can then forward a pro rata payment 6a to lessor 1 and a pro rata payment 6b to the temporary provider 4.

The next procedure is use of article 2 by lessee 4. At the end of the rental period, lessee 4 retains possession of the article under the fair use policy instead of returning it to the previous temporary provider, which in this case is lessee 3. The article is automatically available for request by the next user, such as lessee 5 in FIG. 1C.

Alternatively, lessee 4 has the possibility of extending the article 2 booking into the future to a new end date or to book the article for a new date in the future if the article has not already been requested by another user in the system and the system allows for it.

An optional procedure can be provided by the system for a user review. Lessees or temporary providers are desirably able to enter comments regarding their experience with the previous temporary provider and/or the article into the system.

The system and method of the invention can continue the “rent and keep” procedures through multiple lessees. Desirable embodiments of the invention include options for return of the article to the owner, lessor 1, and for sale of the article to a lessor or third party or other disposal of the article.

Desirable embodiments of the invention permit lessor 1 (the owner) to monitor the physical location of the article, the lessee in possession of the article, and revenue generated and distributed from rental fees for the article. The revenue generated by a user on the platform can be transferred at a later stage to a chosen account unless it consists of points or credits which are not transferable and reside in the systems to be used for future rentals.

Lessor 1 can request return of the article by a simple booking made through the system. In this situation, the current temporary provider is not entitled to receive or share any funds for returning the article to lessor 1 because lessor 1 is the owner of the article.

A desirable embodiment of the invention includes one or more sensors in the article capable of sharing data relevant for the system. Relevant data can include usage of the article, for example, by recording the duration or number of cycles of operation or intensity of use. This information can be used by lessor 1 or a third party designated by lessor 1 in order to (1) alert automatically when maintenance or repair of the article is required, (2) calculate a depreciated deposit value or rental price over time, and/or (3) signal when the article is due for retirement from the system.

An alternative embodiment of the “rent and keep” invention is for sellers of goods or services or retailers such as shoe or garment retailers. Shoes, garments, personal products, and other items are sold in sizes and colors or with other personal preferences selected by the end user or customer. A customer can, for example, try on a number of different models of shoes of the same size but determine that not all of the shoes of the same size fit comfortably. In similar manner, a sample of a garment, once inspected by a customer, may be determined not to match or coordinate with the colors, designs, or materials of the customer's other garments.

Customers, after a brief inspection, evaluation, or sampling of a product or service, can decide not to own or keep the product or service. Such decisions can cause the customers to return the goods or request a termination and refund of a service. In Internet-based or electronic commerce, such reactions cause the seller to ship a product to the customer and then pay to have the product shipped back to the seller. Also, the seller incurs the burden of reversing the transaction.

This embodiment of the invention can decrease the absolute number of products requiring shipping. The invention can reduce the number of returns by desirably offering a small number of key items as samples which are tried and shared desirably for free by multiple customers for a limited time. Retailers can offer customers samples to try on for fit, comfort, or other criteria. If the customer finds the sample acceptable, the customer can purchase a new product of the same size and model of the sample. The customer can then ship the sample to the next interested customer for evaluation.

In this embodiment of the invention, the seller or retailer of an article is the “original lessor” or “owner.” The customer evaluating the sample is the “lessee” or “renter.” This embodiment of the invention can increase customer trials, sales, and word of mouth, while being ecologically and economically viable by reducing returns, waste, and used items offered as a discount in discount outlets.

The value for customers using this embodiment of the invention is access to a free trial before buying, a sharing experience with other customers, and a good feeling about reducing waste.

A retailer using this embodiment of the invention rents an item desirably for free for a limited time in a “rent and return” model. Designated samples of products are shipped by the retailer to interested customers. The customers test, evaluate, or try on the samples and purchase or do not purchase a new product of the sample. Then, the sample is shipped by the customer to another customer who is interested in trying the sample.

Each lessee can try the item for a finite amount of time, such as one day, and ship the sample to the next customer in line. The shipping information can be provided by the system.

The value of “rent and keep” is not to reduce the number of shipping. Although the number of shipments might be reduced for the people who order one item at a time, this would not work for people who order multiple items at a time. The shipping and handling costs are typically a small part of the overall return costs.

The value of this alternative embodiment is for retailers to create a program for people to try “trial items” for free, and share them with others, instead of returning the items to a warehouse. This alternative embodiment enables retailers to reduce discounts and waste by reducing returns. An item is less likely to be returned if it has been tried and evaluated by the customer.

Sales improve because customers will buy more if they can try as sample. The retailer's inventory can be reduced.

Retailers can encourage customers to try items and send them to the next customer perhaps with a personal note. Customers can be encouraged to circulate items as quickly as possible through incentives such as coupons.

The customer benefits from this alternative embodiment of the invention because:
The end customers can try a trial item for free without paying upfront;
The customer can forward and recommend a sample product to a friend and receive points and rewards for the act;
The customer can try multiple products without guilt or hassle; and
The customer reduces wastage and feels good about participating in an environmentally friendly program.

Retailers benefit from a reduction of returned items that must be sold at discount or discarded.

The system and method of the invention desirably include rules that apply during the “rent and keep” process (see generally the flow charts of FIG. 1). These rules can vary according to the type and sophistication of consumers for a particular use of the invention. In other words, the rules for renting common household personal property can vary significantly from rules for renting farm equipment or heavy machinery. Further, the rules for renting specialized equipment such as medical equipment to sophisticated users in the medical professions will vary from renting home-use medical equipment to patients.

The following rules are intended as an example set of rules for a preferred embodiment of the invention. This example is oriented toward renting personal property from individuals to other individuals in a community. A “rental period” for this example is any number of days between two dates when an item or an article is rented.

A first rule is to prohibit overlap of rental periods for a particular article. This rule simplifies identifying the possession and location of the article as well as the responsibilities associated with a particular temporary provider.

A second rule is that at temporary provider or lessee in possession of an article must always be available. Acceptance within the system of responsibility for being a temporary provider or a lessee requires availability in order for a new potential lessee to be able to request an article and receive transfer of the article. The system can desirably accommodate exceptions such as exempting a “professional,” who is a temporary provider or a lessee from availability on legal holidays, Sundays, or vacations.

A third rule is that an article is available. Management of an article availability is performed by the system and not by an owner or temporary provider. The person or entity in possession of an article outside of a booking period must make the article available for transfer to a new lessee.

If an article available for rent is requested and there is at least one day in the week prior to the rental period which is not a holiday or Sunday, the temporary provider must agree on a suitable time for transfer of the article to the new lessee. It is conceivable that the system can charge a penalty where a temporary provider fails to meet this obligation.

A fourth rule permits the lessor or user in possession of the article to approve or deny the request via the system, when a lessee makes a request through the system for the article for a specific rental period. Where an owner makes as request for the article, only the owner can caned his or her request. However, it is up to the owner and temporary provider to arrange for transfer of the article.

The system can desirably award “points” when temporary providers and lessees accept a rental request, demonstrate courtesy toward other users of the article, or otherwise behave in a manner that increases the level of trust toward the system and the temporary providers or lessees. Conversely, the system can desirably inform the owner or others in the system of denied requests or report abuse.

A fifth rule relates to changes in the location of the article. Desirably, when a temporary provider receives two requests for an article and the requested periods of use are different, the system will notify the user requesting the article for the later date if the article's location has changed to a new location and a new temporary provider.

Alternatively, the system desirably permits the intervening user to receive and then return the article to the same temporary provider. The intervening user “rents and returns” the article as originally booked to the temporary provider, and the pickup location does not change for the later user.

A sixth rule involves cancellation of a reservation for rental of an article. A reservation fee or other minimal fee can be charged by the system if the rental is canceled. The system will inform the user or users affected by a cancellation including notification of any change in location for a later booked user to obtain the article from a current user.

A seventh rule involves the payment for rental of an article. The rental price paid by second or subsequent user is desirably divided between as current user and the lessor or owner. FIGS. 1B and 1C illustrate this situation.

The system and method of the invention compensate the current lessee or user and the owner of an article for the next successful rental to a new lessee. The current user in this manner receives compensation through the system for distributing the article, and the lessor or owner is compensated for placing the article in the system for rent. The lessor or owner can retrieve the article at any time without compensating the current user of the article as long as the article is available in the system. Availability in the system means that a request for a rental period of the article has not been granted by the current user.

Alternative embodiments of the payment procedures according to the invention can include variations in the pro rata share of payment made to lessees as the equipment ages as well as incentives to lessees performing as temporary providers. Variations can include (1) paying a user the same fee independently of the rental period requested by a subsequent user and (2) providing an incentive to the current user to encourage the net user to become part of the system or network of recurring users. Incentives can be provided by cash payments or an awards system as discussed above.

An eighth rule involves establishing a trust program. For example, after each delivery or transfer of an article, the system desirably provides the opportunity for a user to rate the experience with the previous lessor or user and vice versa. Points, for example, in the form of one to five stars can be assigned to the lessee or lessor being rated. These points can be accompanied by a short text message. The system can monitor such ratings, make the ratings available to others, and award incentive credits when appropriate to those receiving good ratings.

Another example of a trust program is permitting a user to rate an article at the end of each rental period. Again, a point system of one to five stars can be used with a short text message. The system can desirably monitor the ratings to provide an alert to as lessor if a rating indicates difficulties with the article.

A trust program desirably includes a reporting module when a user damages an article. The user can contact the lessor or owner and resolve the issue to the lessor's satisfaction. The lessor can review the user. An insurance can desirably be offered on the system to offer a protection against breakage for lessees borrowing an item.

A ninth rule desirably provides interactive procedures that increase a user's interest in the system and desire to enter a network. Such procedures can be presented in the format of a game to users. A simple example of such a game format can be as follows.
The system can award points to users or lessors if they accept a rental request on the first presentation of the request and/or within as short period of time from the request being entered into the system.
The system can award points to a user or lessor after each successful transfer of an article.
The system can delete points from a user upon a rental cancellation.
The system award points to a user for creating an account or for recruiting others.
   Users can elect to be paid in points rather than currency for the rental of an article.

A tenth rule desirably provides procedures for dispute avoidance and resolution. At any time, the system desirably provides a mechanism for a user to communicate with the lessor if there is difficulty with an article, for example, if the article is broken, stolen, lost, etc. An acceptable resolution process is described in the website of the application. A brief explanation of a desirable dispute avoidance and regal don procedure is as follows.

A first dispute avoidance procedure is that lessors (owners) can book their own articles. Lessors may book their own articles if they desire to use them in the future for a specific period. Pickup of the article is desirably done by the lessor. There is no rental fee for booking one's own article.

A second dispute avoidance procedure involves approving or refusing an article request. It is the responsibility of a Temporary Provider to approve or refuse an article request. In principle, all requests can be approved, unless the profile or behavior of the potential user requesting the article appears suspicious. Requests from the original lessor must be accepted unless the article is committed to a current rental agreement. The user and lessor can negotiate the terms necessary for transferring the article back to the lessor.

A third dispute avoidance procedure involves communications between users for transfer of an article. A subsequent user is obligated to communicate early enough with the Temporary Provider, who is in possession of the article, to ensure that there is sufficient time to arrange for transfer of the article before the rental period begins. A Temporary Provider who is not available prior to the next booked rental period is obligated to inform the next user through the system to facilitate establishing a time for the transfer.

A fourth dispute avoidance procedure involves the refusal of a potential lessee or user to accept an article from the Temporary Provider or lessor. In situations where potential users decline to accept the article, they must inform the system immediately and enter an explanation. This entry can be sent directly to the lessor of the article to contact the current user in possession of the article. The system desirably refunds rental fees for the article automatically.

A fifth dispute avoidance procedure can detail user responsibility for a rented article. The responsibility for an article starts when the user receives the article and ends when the article is transferred through the system to another, approved user or to the lessor.

The system desirably includes standardized procedures for establishing financial values related to the article and its use within the system and method. The financial procedures can establish the value of the article, deposit amount, and rental fees for the article's use.

A first financial procedure is to establish a value for an article. This value is typically equal to the market value of the article according to the lessor. This value can be a zero value.

A second, optional financial procedure is to establish a deposit amount if desired by the lessor. A desirable default deposit amount can be equal to the article's current market value, if any is established. A user must forfeit to the lessor the full deposit when the article is broken or damaged by the user. A trust account can be established with a bank to hold deposits until the system acknowledges return of the article and the new temporary provider and/or lessor accepts the condition of the returned article. The deposit is then released through the system.

A third financial procedure provides for depreciation of the article's value and the related deposit amount. An article automatically loses part of its value after each rental by a percentage of the rental value as defined by the system. Depreciation values are often standard according to local industry accounting practices or tax regulations for specific categories of personal property. A faster rate of devaluation of the rental fee and deposit amount can be established by the lessor where a particular article has incurred excessive use. Alternatively, depreciation can be stopped once the article's value reaches a pre-determined percentage of the original value and the article remains useful.

A fourth financial procedure amends rental fees. Appropriate rental fees can be derived from the article's market value and rental category. Therefore, the system can desirably evolve rental values in parallel with an article's market value.

The system and method of the invention desirably include a tracking system to monitor the location of an article for its lessor. Desirably, a lessor can track registered users of the article via an online or mobile application. The application can monitor the user's identification as well as location of the article. Each user can desirably access the system to obtain a list of his or her rented articles, rental histories for the articles, expiration dates of currently rented articles, and future bookings for the articles.

The system and method of the invention include a transfer protocol fur transfer of an article from one user to the next. For example, if a lessor provided an article to as first user and then approves a second user to rent the article after the first user, the system desirably facilitates transfer of the article. The system can seek acknowledgment from the first user of the second user's booking. This acknowledgment can be electronic and include a confirmation procedure that notifies the first user of the second user's rental period and the requirement for transfer of the article. This module of the system desirably allows for entry of the current state of the article regarding its function or any defect inhibiting its function. Again, the second user can refuse the article and inform the lessor. Users can also enter minor visual defects for an otherwise functional article. These entries can be used to determine future rental and deposit values.

The system and method of the invention also desirably include monitoring and alerts for service, maintenance, and shipping as discussed above. The lessor of an article is, typically, responsible for maintenance or repair of the article. The system will provide an application program interface, or “API,” that will enable the lessor to contact a maintenance and/or pickup center for the purpose of evaluating and completing repairs. Additional services can be provided via this API such as, but not limited to, shipping the article to the lessor or next user.

Finally, the system and method of the invention also desirably provide a data warehouse to monitor the usage of the systems and share relevant anonymous user, usage, socio-demographics, reviews and article data with third party providers or partners such as but not limited to insurance providers, marketers, and consumer review agencies.

1. A method for renting portable property comprising:
entering on a processor and storage system via information network identification of an article of portable property for rent;
receiving a plurality of requests via the information network from potential lessees to rent the article for requested rental periods;
sorting by the processor and storage system the requests to rent the article according to a chronology of the requested rental periods;
agreeing via the information network to rent the article to a plurality of lessees according to the chronology of the requested rental periods;
transferring possession of the article from a lessor to a first lessee, the first lessee being first in the chronology of the sorted, requested rental periods;
transferring sequentially the article between lessees according to the chronology of the sorted, requested rental periods;
monitoring for the lessor by the processor and storage system each rental and transfer of the article; and
distributing by the processor and storage system a payment for each rental of the article.

2. The method for renting of claim 1 wherein the identification of the article includes a location of the article.

3. The method for renting of claim 2 wherein the identification of the article includes a rental value for the article.

4. The method for renting of claim 3 wherein the identification of the article includes a fixed or limited rental duration.

5. The method for renting of claim 3 wherein the requests by potential lessees include competitive bidding to purchase the article.

6. The method for renting of claim 3 wherein the processor and storage system calculates a reduced rental value, required deposit, or purchase price based upon predetermined criteria including the usage of the article or the age of the article.

7. The method for renting of claim 1 wherein the sorting of the requests to rent denies requests for rental periods that begin during a pending rental period.

8. The method for renting of claim 1 further comprising:
qualifying the potential lessees by the processor and storage system based upon predetermined criteria.

9. The method for renting of claim 8 wherein the predetermined criteria for qualifying the potential lessees includes as geographical location of each of the potential lessees in relation to a lessor of the article.

10. The method for renting of claim 8 wherein the predetermined criteria for qualifying the potential lessees includes as credit score for each of the potential lessees.

11. The method for renting of claim 8 wherein the predetermined criteria for qualifying the potential lessees includes a review of a numerical rating for each of the potential lessees in a database of the processor and storage system.

12. The method for renting of claim 1 wherein the monitoring by the processor and storage system includes tracking geographically a location of the article.

13. The method for renting of claim 12 wherein the tracking geographically a location of the article is by an RFID attached to the article.

14. The method for renting of claim 1 wherein the agreeing to rent the article includes selecting acceptable bids submitted by potential lessees of the article through the processor and storage device based upon predetermined criteria.

15. The method for renting of claim 14 wherein the predetermined criteria for selecting acceptable bids submitted by potential lessees of the article through the processor and storage device includes denying bids for failure of the potential lessees to submit an agreement to a minimum rental value, a minimum rental period, or a required deposit.

16. The method of claim 1 wherein the article is a sample of a product for evaluation by the first lessee before the first lessee decides whether to purchase the product, the first lessee forwards the sample to another lessee for evaluation.

17. A system for renting portable property comprising:
communication devices for submitting individually a plurality of requests via an information network from potential lessees to rent an article for requested rental periods;
a processor and storage system in communication with the communication devices via the information network whereby
a. identification of the article of portable property for rent can be entered and displayed;
b. requests to rent the article can be sorted according to a chronology of the requested rental periods;
c. agreements can be made via the information network to rent the article to a plurality of lessees according to the chronology of the requested rental periods;
d. entry is received of possession of the article from a lessor to a first lessee, the first lessee being first in the chronology of the sorted, requested rental periods; and sequential transfers the article between lessees according to the chronology of the sorted, requested rental periods;
e. the lessor can monitor each rental and transfer of the article; and
f. distribute a payment for each rental of the article.
